(19) United States
(12) Patent Application Publication
(10) Pub. No.: US 2014/0246925 A1
(43) Pub. Date: Sep. 4, 2014

(54) Power Grid Load Monitor and Shed Control

(71) Applicant: MICROCHIP TECHNOLOGY INCORPORATED, Chandler, AZ (US)

(72) Inventors: Stephen B. Porter, Gilbert, AZ (US); Michael Ballard, Phoenix, AZ (US)

(73) Assignee: MICROCHIP TECHNOLOGY INCORPORATED, Chandler, AZ (US)

(21) Appl. No.: 13/784,696

(22) Filed: Mar. 4, 2013

(51) Int. Cl. H01H 35/00

(52) U.S. Cl. CPC H01H 35/00
USPC 307/115; 307/129

(57) ABSTRACT

A line frequency monitoring and load shedding control apparatus is placed in or closely coupled to a power load and monitors the line frequency of the alternating current electric power source supplying the power load. When a decrease in line frequency is detected, this line frequency monitoring and load shedding control apparatus may interrupt certain portions of the power load, thereby allowing the power source frequency to stabilize. Subsequently, the line frequency monitoring and load shedding control apparatus makes a determination to return operation of the load that was shed to a normal state of operation as the power line frequency recovers to a normal operating frequency. Fixed time delays, e.g., adjustable, programmable, etc., and/or pseudo random time delays may be incorporated to sequentially reconnect the loads back onto the power source, thereby preventing the loads previously shed from being reconnected all at the same time.

### TECHNICAL FIELD

The present disclosure relates to load shedding of power utilization equipment, and, more particularly, to a line frequency monitoring and load shedding control apparatus, system and method.

### BACKGROUND

Power generation companies, power distribution companies, and government agencies are trying to manage our growing power needs. The largest issue to overcome is the need to generate enough power to meet the daily peak demands that may only last 1-2 hours per day. This requires the total power generation capacity available to meet or exceed the maximum daily peak demand. In order to meet this increasing daily demand without having to build new power plants, power companies are instituting higher electricity rates during the peak demand time periods. While this is helping to change customer's power usage behavior, the potential for brown-outs or black-outs is still high. The only way to prevent these brown-outs or black-outs, without having to build new power plants, is to disconnect non-critical loads when a brown-out or black-out is inevitable. The Department of Energy, power generation companies, power distribution companies, metering companies, and appliance manufacturers are attempting to create systems to actively shed loads from the power grid that are not critical, e.g., smart power meters, smart power grid, etc. These load shedding and computer network system technologies have been in development for years and require sophisticated communications and computer network systems for allowing the power plants to communicate with and control the substations, smart meters, and then ultimately turn off specific power loads, i.e., “load shedding.” Based on the size of the investments required to implement these systems, it may take many years to get these systems up and running.

### SUMMARY

Therefore what is needed is a simple line frequency monitoring and load shedding control apparatus, system and method for disconnecting loads from a power grid, rather then having to use sophisticated communications and computer network systems to remove these loads from the power grid.

According to an embodiment, a power line frequency monitoring and load shedding control apparatus may comprise: a controllable power switch having a power input, a power output, and a control input, wherein the power input may be adapted for coupling to a power source and the power output may be adapted for coupling to a power load; and a line frequency monitoring and load shedding control circuit having a line input and a control output, wherein the line input may be adapted for coupling to the power source and the control output may be coupled to the control input of the controllable power switch; the line frequency monitoring and load shedding control circuit monitors a line frequency of the power source, wherein when the line frequency may be at substantially a certain frequency the controllable power switch may be controlled by the line frequency monitoring and load shedding control circuit to couple the power source to the power load, and when the line frequency may be less than the certain frequency the controllable power switch may be controlled to decouple the power source from the power load.

According to a further embodiment, a time delay circuit may be used to delay recoupling the power source to the power load. According to a further embodiment, the time delay circuit has a programmable time delay. According to a further embodiment, the time delay circuit has a pseudo random time delay.

According to a further embodiment, the apparatus may further comprise: a plurality of a controllable power switches, each one having a power input, a power output and a control input, wherein the power inputs may be adapted for coupling to the power source and the power outputs may be adapted for coupling to respective ones of a plurality of power loads; and the line frequency monitoring and load shedding control circuit further comprises a plurality of control outputs coupled to respective control inputs of the plurality of controllable power switches. According to a further embodiment, a plurality of time delay circuits may sequentially delay recoupling the power source to the plurality of power loads.

According to a further embodiment, the line frequency monitoring and load shedding control circuit may comprise: a zero-cross detector having an input coupled to the power source and an output, wherein a zero-cross pulse may be produced from the output each time a waveform of the power source may be at substantially zero volts; a power supply having an input coupled to the power source and at least one direct current voltage output for powering the line frequency monitoring and load shedding control circuit; a timer/counter; a precision clock having a clock output coupled to a clock input of the timer/counter, wherein the clock output comprises a plurality of clock pulses; a digital processor and memory; and a control output driver having an input coupled to the digital processor and an output used as the control output of the line frequency monitoring and load shedding control circuit; wherein the timer/counter starts counting the plurality of clock pulses upon receiving an n zero-cross pulse and stops counting the plurality of clock pulses upon receiving an n+1 zero-cross pulse, where n may be a positive integer value; and the digital processor reads a count value from the timer/counter at each of the n+1 zero-cross pulses, then resets the count value to zero, whereby the digital processor determines the line frequency of the power source from the count value.

According to a further embodiment, a serial interface may be coupled to the digital processor and having a computer interface. According to a further embodiment, a line frequency status display may be coupled to the digital processor. According to a further embodiment, the line frequency status display may be a plurality of light emitting diodes (LEDs) arranged in a pattern to indicate relative line frequency. According to a further embodiment, the certain frequency may be substantially 60.0 Hz. According to a further embodiment, the timer/counter, the precision clock, the digital processor and memory, and the control output driver may be part of a microcontroller. According to a further embodiment, the precision clock may be coupled to a high stability frequency determining element. According to a further embodiment, the high stability frequency determining element may be a crystal frequency determining element. According to a further embodiment, the crystal frequency determining element operates at substantially 8 MHz.

According to another embodiment, an appliance with power line frequency monitoring and load shedding control may comprise: a controllable power switch having a power input, a power output, and a control input, wherein the power input may be adapted for coupling to a power source and the power output may be adapted for coupling to a power load of the appliance; and a line frequency monitoring and load shedding control circuit having a line input and a control output, wherein the line input may be adapted for coupling to the power source and the control output may be coupled to the control input of the controllable power switch; the line frequency monitoring and load shedding control circuit monitors a line frequency of the power source, wherein when the line frequency may be at substantially a certain frequency the controllable power switch may be controlled by the line frequency monitoring and load shedding control circuit to couple the power source to the appliance power load, and when the line frequency may be less than the certain frequency the controllable power switch may be controlled to decouple the appliance power source from the power load.

According to a further embodiment, the appliance power load may be selected from the group consisting of an air conditioning condensing compressor, an electric heat strip, a blower motor, an electric heat strip in an electric clothes dryer, a washing machine motor, an electric heat strip in an oven, electric heating elements in an electric cook top, an electric heat strip in an electric water heater, and a dishwasher motor and electric heat strip.

According to yet another embodiment, a method for line frequency monitoring and load shedding control, may comprise the steps of: measuring a line frequency of a power source; coupling a power load to the power source with a controllable power switch when the line frequency may be at substantially a certain frequency; and decoupling the power load from the power source with the controllable power switch when the line frequency may be less than the certain frequency.

According to a further embodiment of the method, recoupling the power load to the power source may be delayed for a time period. According to a further embodiment of the method, the time period may be programmable. According to a further embodiment of the method, the time period may be pseudo randomly generated.

According to still another embodiment, a power generation and power utilization system may comprise: a power source; a power load; a controllable power switch having a power input, a power output, and a control input, wherein the power input may be coupled to the power source and the power output may be coupled to the power load; and a line frequency monitoring and load shedding control circuit having a line input and a control output, wherein the line input may be coupled to the power source and the control output may be coupled to the control input of the controllable power switch; the line frequency monitoring and load shedding control circuit monitors a line frequency of the power source, wherein when the line frequency may be at substantially a certain frequency the controllable power switch may be controlled by the line frequency monitoring and load shedding control circuit to couple the power source to the power load, and when the line frequency may be less than the certain frequency the controllable power switch may be controlled to decouple the power source from the power load.

According to a further embodiment, the power source may be selected from the group consisting of an electric utility power grid, an engine generator set, a wind turbine, a water wheel driven turbine, and a battery powered inverter. According to a further embodiment, the power load may be selected from any one or more of the group consisting of an air conditioning condensing compressor, an electric heat strip, a blower motor, an electric clothes dryer, a washing machine, an oven, an electric cook top, an electric water heater, and a dishwasher.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic block diagram of a line frequency monitoring and load shedding controlled power system, according to specific example embodiments of this disclosure;

FIG. 2 illustrates a schematic block diagram of a line frequency monitoring and load shedding control apparatus, according to a specific example embodiment of this disclosure;

FIG. 3 illustrates a schematic diagram of a line frequency monitoring and load shedding control apparatus, according to another specific example embodiment of this disclosure;

FIG. 4 illustrates a schematic graph of exemplary trip points and line frequency display indication during operation of a line frequency monitoring and load shedding control apparatus, according to specific example embodiments of this disclosure;

FIG. 5 illustrates a schematic block diagram of a line frequency monitoring and load shedding control apparatus in an emergency generator set, according to yet another specific example embodiment of this disclosure; and

FIG. 6 illustrates a schematic block diagram of a line frequency monitoring and load shedding control apparatus integral with an appliance, according to still another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

In a power plant, a turbine, e.g., steam, natural gas, water, wind, etc.; or a diesel engine drives an alternating current (AC) electric generator at a constant, precise rotational speed (revolutions per minute—RPM) to maintain a 60 Hertz (Hz) line frequency from the generator. Photovoltaic (PV) panels and AC inverters are also used to generate AC power at a 60 Hz line frequency. As loads connected to the generator increase, more power output is required from the generator with a subsequent increase in the amount of energy (horse power) required from the driving turbine or engine. As the turbine or engineer reach its maximum available output power, no more energy can be supplied to the generator, whereby the rotational speed thereof will start to decrease and the generator power output line frequency also decreases proportionally.

A simple line frequency monitoring and load shedding control apparatus may be placed in or closely coupled to a power load, e.g., appliance (washer, dryers, refrigerators, toasters, ovens, cook tops), air conditioning and pool equipment, water heaters, etc., to monitor the line frequency of the alternating current electric power source supplying the power load(s). When a decrease in line frequency is detected, this line frequency monitoring and load shedding control apparatus can interrupt certain portions or all of the power load, thereby allowing the power grid frequency to stabilize. For example, but not limited to, an electric dryer or space heater could turn off the electric heating element thereof but continue operation of the fan motor. Similarly, air conditioning and cooling (refrigerator) can interrupt operation of the condensing compressor while maintaining air blower/fan operation. Subsequently, the line frequency monitoring and load shedding control apparatus can make a determination to return operation of the load that was shed to a normal state of operation as the power line frequency recovers to a normal operating frequency. Fixed time delays, e.g., adjustable, programmable, etc., and/or pseudo random time delays may be incorporated to sequentially reconnect the loads back onto the power grid, thereby preventing the loads previously shed from being reconnected all at the same time.

Referring now to the drawings, the details of specific example embodiments are schematically illustrated. Like elements in the drawings will be represented by like numbers, and similar elements will be represented by like numbers with a different lower case letter suffix.

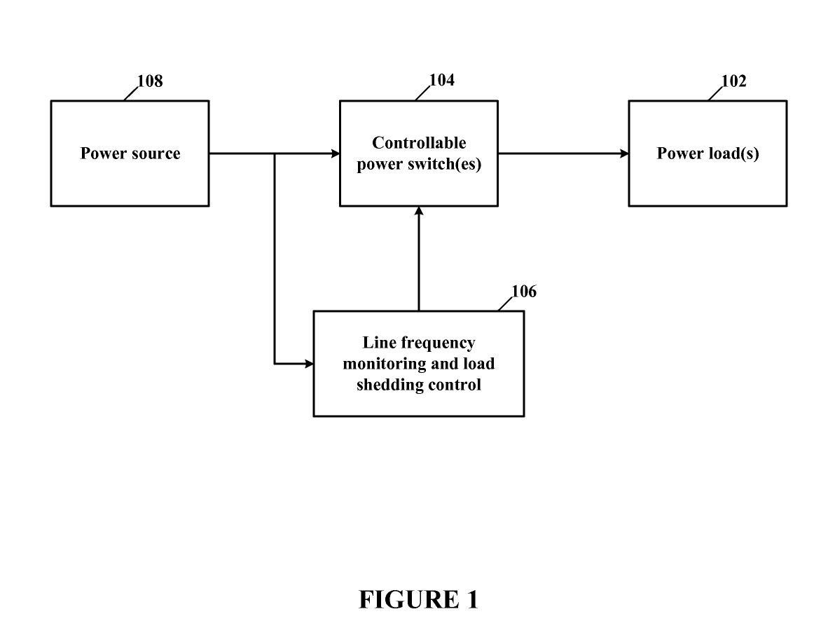

Referring to FIG. 1, depicted is a schematic block diagram of a line frequency monitoring and load shedding controlled power system, according to specific examples of this disclosure. A power source 108 may be, for example but not limited to, a power utility distribution grid connected to a plurality of turbine-generators, an engine-generator, a wind turbine, a battery power inverter (e.g., photovoltaic charged), etc. At least one power load 102 may be, for example but not limited to, one or more appliance (washer, dryers, refrigerators, toasters, ovens, cook tops), air conditioning and pool equipment, water heaters, etc. The at least one power load 102 may be coupled to and decoupled from the power source 108 with at least one controllable power switch 104. The at least one controllable power switch 104 may be an electromechanical contactor (relay), a solid state switch, e.g., triac, SCR, solid state relay, etc., and may be an existing part of the power load 102, e.g., power contactor in an air conditioning condensing unit, or external but closely coupled to the power load 102. e.g., controllable power receptacles.

A line frequency monitoring and load shedding control apparatus 106 may precisely monitor the frequency of the alternating current line voltage from the power source 108. When the line frequency goes below a certain frequency, the at least one controllable power switch 104 will be instructed to disconnect the at least one power load 102 from the power source 108 until such time when the line frequency returns to the certain frequency, e.g., 60 Hz.

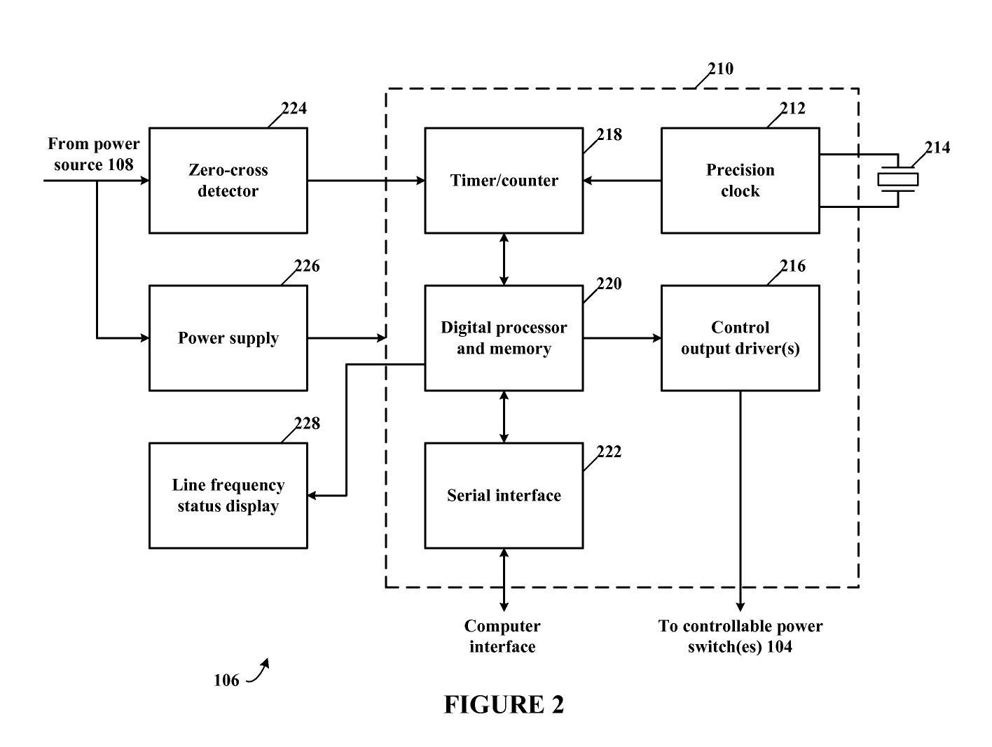

Referring to FIG. 2, depicted is a schematic block diagram of a line frequency monitoring and load shedding control apparatus, according to a specific example embodiment of this disclosure. The line frequency monitoring and load shedding control apparatus 106 may comprise a zero-cross detector 224, a power supply 226, a line frequency status display 228, a timer/counter 218, a digital processor and memory 220, a serial interface 222, a precision clock 212, a crystal frequency standard 214, and at least one control output driver 216.

A microcontroller 210 may include at least the timer/counter 218, digital processor and memory 220, serial interface 222, precision clock 212 and at least one control output driver 216. The power supply 226 may be any type of power supply that converts the power source AC line voltage to appropriate voltage(s) to run the microcontroller 210. The line frequency status display 228 may be, for example but not limited to, light emitting diodes (LEDs). The zero-cross detector 224 sends a zero cross signal to the timer/counter 218 each time the sinusoidal waveform of the power source crosses a zero value. The timer/counter 218 uses the zero cross signals to start and stop counting by the timer/counter 218. Wherein the period time (frequency) of every other half-cycle is counted and then during the uncounted half-cycle the digital processor 220 may read the count value from the timer/counter 218. The precision clock 212 uses the crystal frequency standard 214, e.g., 8 MHz, to generate a plurality of clock pulses having a precise frequency that is applied to the timer/counter 218. During the half cycle that the timer/counter 218 is enabled it will count the number of clock pulses between the zero crossings of the power line sinusoidal waveform. The timer/counter 218 may also be configured with a storage register (not shown), wherein whenever a zero cross pulse is received by the timer/counter 218 its present count is transferred to this storage register (not shown), then resets and a new count begins. The digital processor 220 then reads the stored count in the storage register (not shown) to determine the line frequency.

The digital processor 220 reads the count value from the timer/counter 218 and determines the line frequency therefrom. If the line frequency so determined is at the certain frequency then the at least one control output driver 216 maintains the controllable power switch 104 on to provide power from the power source 108 to the at least one power load 102. However, if the line frequency falls below the certain frequency, then the digital processor 220 causes the at least one control output driver 216 to turn the controllable power switch 104 off and thereby disconnect the at least one power load 102 from the power source 108. The timer/counter 218 continues to count clock pulses between zero crossings and the digital processor 220 continues to determine the line frequency from the count values from the timer/counter 218. When the line frequency goes back to substantially the certain frequency then the digital processor 220 will wait a certain time before re-enabling the at least one controllable power switch 104 to reconnect the at least one power load 102 to the power source 108. When there are more then one (a plurality of) power load 102, the digital processor 220 may time sequence (stagger) when each one of the plurality of power loads 102 is reconnected to the power source 108. By time sequencing reconnection of the plurality of power loads 102 there is less chance of significantly overloading the power source 108 until all of the plurality of power loads 102 have been reconnected. These sequence times may be programmed into the digital processor and memory 220, and/or a pseudo random time generator (not shown but can be a function of the microcontroller 210) may be used to generate different times when each one of the plurality of power loads 102 may be reconnected to the power source 108.

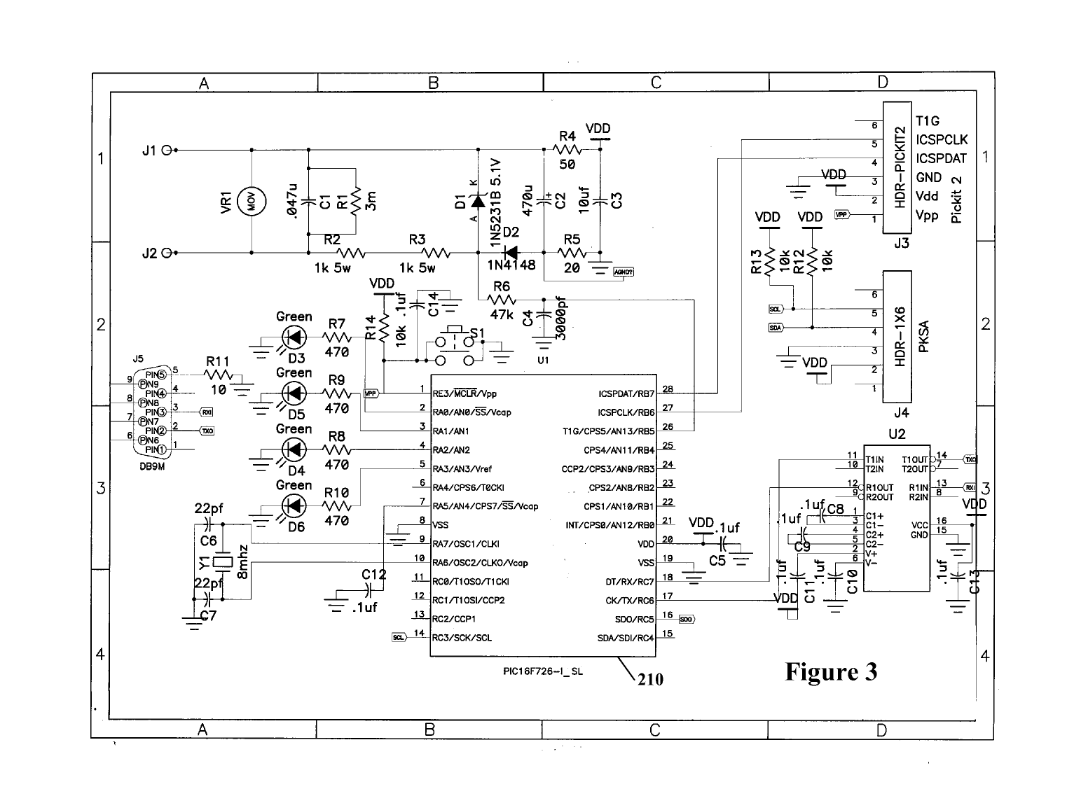

Referring to FIG. 3, depicted is a schematic diagram of a line frequency monitoring and load shedding control apparatus, according to another specific example embodiment of this disclosure. The circuit shown in FIG. 3 substantially works as the line frequency monitoring and load shedding control apparatus 106 shown in FIG. 2 and described hereinabove. Additionally, four LEDs (D3-D6) are shown connected to the microcontroller 210. These four LEDs may be used to indicate line frequency status as more fully described hereinafter.

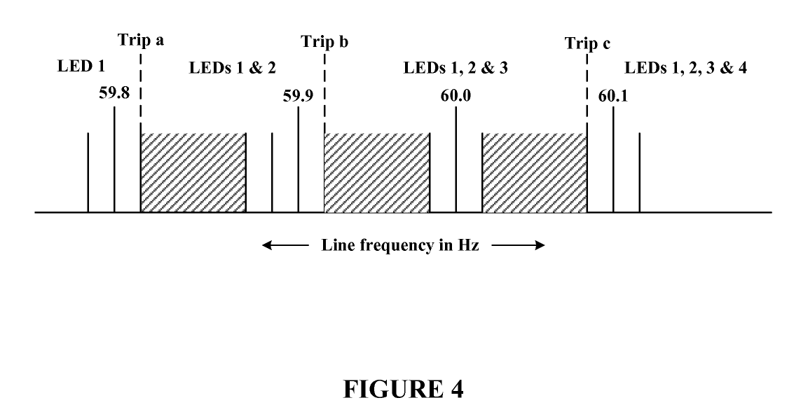

Referring to FIG. 4, depicted is a schematic graph of exemplary trip points and line frequency display indication during operation of a line frequency monitoring and load shedding control apparatus, according to specific example embodiments of this disclosure. The preferred line frequency in the United States of America is 60 Hz. The line frequency may vary under load/no load conditions depending upon how stiff the power capacity is of the power source 108. Trip points may be programmed into the digital processor and memory 220 based upon determining that the power source 108 is operating within a certain range frequencies of the measured line frequency. For example, when the line frequency is greater than 59.9 Hz and less than 60.1 Hz, normal power source conditions are present, and three LEDs may be lit. When the line frequency is less than or equal to 59.9 Hz but greater than 59.8 Hz, the power source may be in a brown-out condition and two LEDs may be lit. When the line frequency is less than or equal to 59.8 Hz the power source may be in a black-out condition and only one LED may be lit. When the line frequency is equal to or greater than 60.1 Hz all four LEDs may be lit.

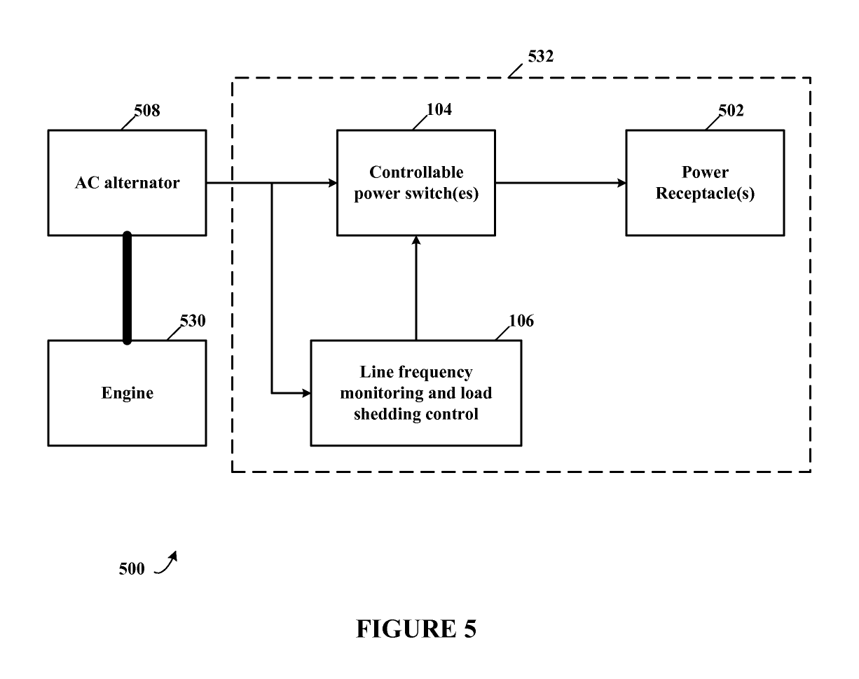

Referring to FIG. 5, depicted is a schematic block diagram of a line frequency monitoring and load shedding control apparatus in an emergency generator set, according to yet another specific example embodiment of this disclosure. An emergency generator set, generally represented by the numeral 500, may comprise an AC alternator-generator 508, an engine 530, at least one controllable power switch 104, line frequency monitoring and load shedding control apparatus 106, and at least one power receptacle 502. The line frequency monitoring and load shedding control apparatus 106 monitors the frequency of the AC alternator-generator 508 and may control operation of the at least one controllable power switch 104 as described more fully hereinabove. Power loads (not shown) may be plugged into a respective one of the at least one power receptacle 502, and connected to and disconnected from the AC alternator-generator 508 (power source) by the at least one controllable power switch 104, according to the teachings of this disclosure.

In is contemplated and within the scope of this disclosure that the at least one controllable power switch 104, the line frequency monitoring and load shedding control apparatus 106, and the at least one power receptacle 502 may be located independent from the AC alternator generator 508 in a housing 532 so that the power load shedding based upon line frequency may be utilized with existing power sources and power loads, and with the benefit of load shedding according to the teachings of this disclosure.

It is contemplated and with the scope of this disclosure that the at least one controllable power switch 104 and the line frequency monitoring and load shedding control apparatus 106 may be, for example but not limited to, part of a power circuit breaker, load shedding module (e.g., used with emergency standby generators), etc.

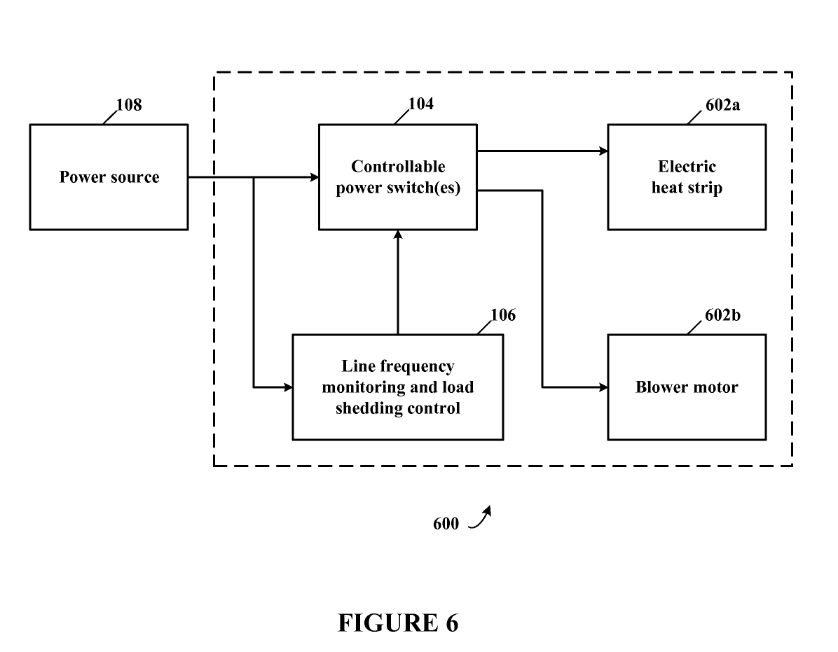

Referring to FIG. 6, depicted is a schematic block diagram of a line frequency monitoring and load shedding control apparatus integral with an appliance, according to still another specific example embodiment of this disclosure. A load shedding appliance, generally represented by the numeral 600, may comprise at least one controllable power switch 104, line frequency monitoring and load shedding control apparatus 106, and at least one power load 602. The appliance 600 will automatically load shed when the power line frequency goes below a certain line frequency, e.g., 60.0 Hz. Based upon whether the line frequency is at a brown-out or black-out condition (see FIG. 4), the at least one controllable power switch 104 may disconnect just the major power load 602a (e.g., electric heat strip) or both power loads 602, respectively.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A power line frequency monitoring and load shedding control apparatus, comprising:
a controllable power switch having a power input, a power output, and a control input, wherein the power input is adapted for coupling to a power source and the power output is adapted for coupling to a power load; and
a line frequency monitoring and load shedding control circuit having a line input and a control output, wherein the line input is adapted for coupling to the power source and the control output is coupled to the control input of the controllable power switch;
the line frequency monitoring and load shedding control circuit monitors a line frequency of the power source, wherein when the line frequency is at substantially a certain frequency the controllable power switch is controlled by the line frequency monitoring and load shedding control circuit to couple the power source to the power load, and when the line frequency is less than the certain frequency the controllable power switch is controlled to decouple the power source from the power load.

2. The apparatus according to claim 1, further comprising a time delay circuit to delay recoupling the power source to the power load.

3. The apparatus according to claim 2, wherein the time delay circuit has a programmable time delay.

4. The apparatus according to claim 2, wherein the time delay circuit has a pseudo random time delay.

5. The apparatus according to claim 1, further comprising:
a plurality of a controllable power switches, each one having a power input, a power output and a control input, wherein the power inputs are adapted for coupling to the power source and the power outputs are adapted for coupling to respective ones of a plurality of power loads; and
the line frequency monitoring and load shedding control circuit further comprises a plurality of control outputs coupled to respective control inputs of the plurality of controllable power switches.

6. The apparatus according to claim 5, further comprising a plurality of time delay circuits to sequentially delay recoupling the power source to the plurality of power loads.

7. The apparatus according to claim 1, wherein the line frequency monitoring and load shedding control circuit comprises:
a zero-cross detector having an input coupled to the power source and an output, wherein a zero-cross pulse is produced from the output each time a waveform of the power source is at substantially zero volts;
a power supply having an input coupled to the power source and at least one direct current voltage output for powering the line frequency monitoring and load shedding control circuit;
a timer/counter;
a precision clock having a clock output coupled to a clock input of the timer/counter, wherein the clock output comprises a plurality of clock pulses;
a digital processor and memory; and
a control output driver having an input coupled to the digital processor and an output used as the control output of the line frequency monitoring and load shedding control circuit;
wherein the timer/counter starts counting the plurality of clock pulses upon receiving an n zero-cross pulse and stops counting the plurality of clock pulses upon receiving an n+1 zero-cross pulse, where n is a positive integer value; and
the digital processor reads a count value from the timer/counter at each of the n+1 zero-cross pulses, then resets the count value to zero, whereby the digital processor determines the line frequency of the power source from the count value.

8. The apparatus according to claim 7, further comprising a serial interface coupled to the digital processor and having a computer interface.

9. The apparatus according to claim 7, further comprising a line frequency status display coupled to the digital processor.

10. The apparatus according to claim 9, wherein the line frequency status display is a plurality of light emitting diodes (LEDs) arranged in a pattern to indicate relative line frequency.

11. The apparatus according to claim 1, wherein the certain frequency is substantially 60.0 Hz.

12. The apparatus according to claim 7, wherein the timer/counter, the precision clock, the digital processor and memory, and the control output driver are part of a microcontroller.

13. The apparatus according to claim 7, wherein the precision clock is coupled to a high stability frequency determining element.

14. The apparatus according to claim 13, wherein the high stability frequency determining element is a crystal frequency determining element.

15. The apparatus according to claim 14, wherein the crystal frequency determining element operates at substantially 8 MHz.

16. An appliance with power line frequency monitoring and load shedding control, comprising:
a controllable power switch having a power input, a power output, and a control input, wherein the power input is adapted for coupling to a power source and the power output is adapted for coupling to a power load of the appliance; and
a line frequency monitoring and load shedding control circuit having a line input and a control output, wherein the line input is adapted for coupling to the power source and the control output is coupled to the control input of the controllable power switch;
the line frequency monitoring and load shedding control circuit monitors a line frequency of the power source, wherein when the line frequency is at substantially a certain frequency the controllable power switch is controlled by the line frequency monitoring and load shedding control circuit to couple the power source to the appliance power load, and when the line frequency is less than the certain frequency the controllable power switch is controlled to decouple the appliance power source from the power load.

17. The appliance according to claim 16, wherein the appliance power load is selected from the group consisting of an air conditioning condensing compressor, an electric heat strip, a blower motor, an electric heat strip in an electric clothes dryer, a washing machine motor, an electric heat strip in an oven, electric heating elements in an electric cook top, an electric heat strip in an electric water heater, and a dishwasher motor and electric heat strip.

18. A method for line frequency monitoring and load shedding control, comprising the steps of:
measuring a line frequency of a power source;
coupling a power load to the power source with a controllable power switch when the line frequency is at substantially a certain frequency; and
decoupling the power load from the power source with the controllable power switch when the line frequency is less than the certain frequency.

19. The method according to claim 18, further comprising the step of delaying recoupling the power load to the power source for a time period.

20. The method according to claim 18, wherein the time period is programmable.

21. The method according to claim 18, wherein the time period is pseudo randomly generated.

22. A power generation and power utilization system, said system comprising:
a power source;
a power load;
a controllable power switch having a power input, a power output, and a control input, wherein the power input is coupled to the power source and the power output is coupled to the power load; and
a line frequency monitoring and load shedding control circuit having a line input and a control output, wherein the line input is coupled to the power source and the control output is coupled to the control input of the controllable power switch;
the line frequency monitoring and load shedding control circuit monitors a line frequency of the power source, wherein when the line frequency is at substantially a certain frequency the controllable power switch is controlled by the line frequency monitoring and load shedding control circuit to couple the power source to the power load, and when the line frequency is less than the certain frequency the controllable power switch is controlled to decouple the power source from the power load.

23. The power generation and power utilization system according to claim 22, wherein the power source is selected from the group consisting of an electric utility power grid, an engine generator set, a wind turbine, a water wheel driven turbine, and a battery powered inverter.

24. The power generation and power utilization system according to claim 22, wherein the power load is selected from any one or more of the group consisting of an air conditioning condensing compressor, an electric heat strip, a blower motor, an electric clothes dryer, a washing machine, an oven, an electric cook top, an electric water heater, and a dishwasher.
